(19) United States
(12) Patent Application Publication
(10) Pub. No.: US 2014/0047348 A1
(43) Pub. Date: Feb. 13, 2014

(54) Identifying Communication Clients

(71) Applicant: Metaswitch Networks Ltd, Enfield (GB)

(72) Inventor: Mark STEWART, Enfield (GB)

(21) Appl. No.: 13/955,917

(22) Filed: Jul. 31, 2013

(30) Foreign Application Priority Data
Jul. 31, 2012 (GB) 1213590.1

(51) Int. Cl. G06F 3/0484

(52) U.S. Cl. CPC G06F 3/0484
USPC 715/738

(57) ABSTRACT

A computer-implemented method for facilitating the identification of communication clients via a user interface is provided. The communication clients use a communication protocol capable of supporting a plurality of clients which are addressable using a common address of record. At least a first and a second communication client associated with a common address of record are identified. At least one parameter associated with messaging involving the first and second communication clients is selected. The messaging uses the communication protocol. First and second, different, client-specific identifiers for the first and second communication clients respectively are generated based at least partly on the selected at least one parameter. The first and second client-specific identifiers facilitate identification of and disambiguation between the first and second communication clients by a user. At least the first and second client-specific identifiers are transmitted for output to the user via the user interface.

### CROSS REFERENCE TO PRIOR APPLICATIONS

This application claims priority to foreign patent application no. GB 1213590.1 filed Jul. 31, 2012, the disclosure of which is incorporated herein by reference in its entirety.

### TECHNICAL FIELD

The present invention relates to facilitating the identification of communication clients via a user interface.

### BACKGROUND

A user of a telephony service may have multiple telephony devices that are associated with the service. For example, a user may have multiple SIP devices that register for a given Address of Record (AOR) with a SIP Registrar. The default behavior is for a SIP message directed to that AOR to be “forked” by the SIP Registrar to all of the registered devices. There are various scenarios where it can be desirable to have finer control over the way in which SIP messages to the AOR are handled, in particular being able to direct a SIP request to a specific device associated with the AOR.

More generally, telephony service providers often provide a user interface to allow a user to invoke and/or manage the service. It is important, at least in terms of user satisfaction and usability, for the user interface to be able to identify each of the devices in terms that are meaningful to the user to help the user identify and distinguish between their devices.

Globally Routable User Agent URIs (GRUUs, RFC 5627) provide a mechanism for directing initial SIP requests to one of a subscriber's registered SIP clients. The original driver for GRUUs was to help solve issues with certain call flows; for example, particular ways of implementing call transfer. GRUUs (which may take the form: “sip:alice@example.com;gr=kjh29x97us97d”) do not readily facilitate identification by the user of the particular SIP client with which they are associated. In other words, displaying the GRUUs of all of the registered SIP clients would not help the user in identifying their SIP clients via the user interface in itself.

Caller Preferences (RFC 3841) allow the originator of a SIP request to provide a set of “media feature tags” that express its preferences on the characteristics of the device(s) that is to be reached. These are matched by the SIP Registrar, for example a Serving Call Session Control Function (S-CSCF), against media feature tags provided by the device that is to be reached at registration time (User Agent Capabilities, RFC 3840).

RFC 3840 defines a set of feature tags, including a textual “Description” tag. The purpose of the Description tag is not entirely clear—potentially it allows a device to provide a meaningful identifier for itself; for example its make and model, a string that the user could configure on a local UI or the like. However, there are practical problems with relying upon this mechanism to identify devices. Firstly, it requires all of a user's SIP devices to support this feature tag; there is little evidence that this feature tag is actually widely supported. Secondly, the feature tags are carried within the Contact header of SIP REGISTER messages. This may be problematic when Session Border Controllers (SBCs) are deployed as many typical SBC implementations re-write this header and in doing so may obliterate these tags.

US-A1-2009/0210536 describes a system for facilitating transfer of an active session from a first device to a second device associated with the same user. A “Device Swap” menu option may show each of the devices with human readable device names that the user recognizes.

US-A1-2009/0193512 describes a system for addressing a unique device from an address book in which a nickname may be manually assigned to a given device.

It would be desirable to facilitate the identification of communication clients via a user interface. In particular, it would be desirable to facilitate identification and disambiguation of the communication clients via a user interface without requiring user involvement in generating suitable identifiers for the communication clients.

### SUMMARY

According to a first aspect of the invention, there is provided a computer-implemented method for facilitating the identification of communication clients via a user interface, the communication clients using a communication protocol capable of supporting a plurality of clients which are addressable using a common address of record, the method comprising:

identifying at least a first and a second communication client associated with a common address of record;

selecting at least one parameter associated with messaging involving the first and second communication clients, the messaging using said communication protocol;

generating first and second, different, client-specific identifiers for the first and second communication clients respectively based at least partly on said selected at least one parameter, the first and second client-specific identifiers facilitating identification of and disambiguation between the first and second communication clients by a user; and

transmitting at least the first and second client-specific identifiers for output to the user via the user interface.

According to a second aspect of the invention, there is provided an apparatus for facilitating the identification of communication clients via a user interface, the communication clients using a communication protocol capable of supporting a plurality of clients which are addressable using a common address of record, the apparatus comprising:

one or more processors configured to identify at least a first and a second communication client associated with a common address of record;

one or more processors configured to select at least one parameter associated with messaging involving the first and second communication clients, the messaging using said communication protocol;

one or more processors configured to generate first and second, different, client-specific identifiers for the first and second communication clients respectively based at least partly on said selected at least one parameter, the first and second client-specific identifiers facilitating identification of and disambiguation between the first and second communication clients by a user; and

one or more transmitters operable to transmit at least the first and second client-specific identifiers for output to the user via the user interface.

According to a third aspect of the invention, there is provided a computer program product comprising a non-transitory computer-readable storage medium having computer readable instructions stored thereon, the computer readable instructions being executable by a computerized device to cause the computerized device to perform a method for facilitating the identification of communication clients via a user interface, the communication clients using a communication protocol capable of supporting a plurality of clients which are addressable using a common address of record, the method comprising:

identifying at least a first and a second communication client associated with a common address of record;

selecting at least one parameter associated with messaging involving the first and second communication clients, the messaging using said communication protocol;

generating first and second, different, client-specific identifiers for the first and second communication clients respectively based at least partly on said selected at least one parameter, the first and second client-specific identifiers facilitating identification of and disambiguation between the first and second communication clients by a user; and

transmitting at least the first and second client-specific identifiers for output to the user via the user interface.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a schematic representation of a system in accordance with some embodiments.

FIG. 2 is a message flow diagram showing a method in accordance with some embodiments.

### DETAILED DESCRIPTION

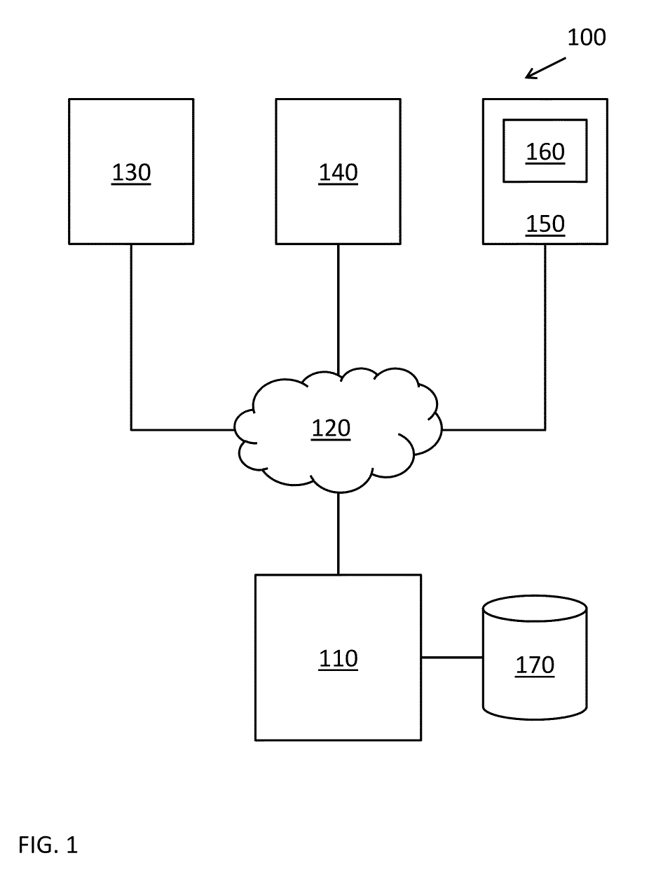

FIG. 1 is a schematic representation of a communications system 100 in accordance with some embodiments. The communications system 100 may be used to facilitate the identification of communication clients via a user interface.

The communications system 100 includes an identification control system 110 that communicates via a communications network 120, such as the Internet, with first and second communication clients 130, 140 and a user device 150 having a user interface 160.

The first and second communication clients 130, 140 are associated with a common AOR. Further communication clients (not shown) may also be associated with the common AOR. The identification control system 110 may be able to identify that first and second communication clients 130, 140 are associated with the common AOR by identifying a set of communication clients that are currently associated with the common AOR and determining whether the first and/or second communication client 130, 140 belongs to that set. The identification control system 110 may be able to identify that the first and second communication clients 130, 140 are associated with the common AOR by transmitting a query to an entity that is responsible for maintaining registrations against the AOR, for example a SIP Registrar, where the query identifies the first and second communication clients 130, 140 and the AOR. There are various other mechanisms by means of which the identification control system 110 can identify that the first and second communication clients 130, 140 are associated with the AOR.

The first and second communication clients 130, 140 may both be SIP communication clients. In other words, the first and second communication clients 130, 140 may both support the use of SIP. In some embodiments, one or both of the first and second communication clients 130, 140 may support one or more additional or different communication protocols, such as Extensible Messaging and Presence Protocol (XMPP). Like SIP, XMPP supports a plurality of communication clients which are addressable using a common address of record. The user device 150 may be or may comprise a communication client that supports the same or different protocol(s) as the first and second communication clients 130, 140. Alternatively, the user device 150 may be used to facilitate identification of the communication clients 130, 140 via the user interface 160 but is not used to conduct communications in accordance with the above-mentioned protocols.

The communications system 100 also includes a database system 170 to which the identification control system 110 has access. The database system 170 stores data associated with the service, including, but not limited to various algorithms which, as will be described in more detail below, may be used to generate client-specific identifiers for the communication clients 130, 140 automatically. The identification control system 110 and/or the database 170 may comprise one or more computing devices such as servers that may be co-located or may be located remotely from each other.

The identification control system 110 selects at least one parameter associated with messaging involving the first and second communication clients 130, 140. The identification control system 110 generates first and second, different, client-specific identifiers for the first and second communication clients 130, 140 respectively based at least partly on the selected at least one parameter. The first and second client-specific identifiers facilitate identification of and disambiguation between the first and second communication clients 130, 140 by the user.

The first and second communication clients 130, 140 may be involved in the messaging by receiving the messaging and/or transmitting the messaging, for example. The messaging may comprise a sequence of one or more individual messages, for example in the form of a message exchange, and uses one or more of the communication protocols identified above, for example SIP, XMPP or the like.

Various different types of parameter associated with the messaging may be used to generate the first and second, different, client-specific identifiers as will be described in more detail below. There are various different types of parameter that may be used to generate the first and second, different, client-specific identifiers and various ways in which the parameter(s) may be associated with the messaging. For example, the parameters may correspond to data included within the messaging (for example header information or data associated with certain headers) and/or data that relates to messaging but is not included in the messaging as such.

The client-specific identifier may be in a user-friendly form, such as a user-friendly display name, icon, image, sound or the like.

The at least one parameter associated with the messaging may have been selected from a set of parameters associated with the messaging in accordance with a parameter selection algorithm. The parameter selection algorithm may be used to identify certain fields, header, data or other information within the messaging that are associated with the parameter and that may be used to generate the client-specific identifiers. The parameter selection algorithm may alternatively or additionally be used to identify certain data associated with the messaging, but that is not contained within the messaging itself that may be used to generate the client-specific identifiers.

Generating a client-specific identifier that identifies the type of a communication client to the user via the user interface 160 may facilitate identification of and disambiguation between the first and second communication clients 130, 140 by the user. This might involve identifying the make and/or model of a hard phone or the application name of a soft client. In the case of the soft client, the underlying platform may be identified.

The type of communication client may, for example, be deduced or derived from the User-Agent header in a SIP REGISTER message. Although the format is not standardized, the User-Agent header typically includes information that identifies, or that can be used to identify, a make and/or model and software version and/or build information associated with a SIP client that transmits the SIP REGISTER message. However, it may not be particularly user-friendly or helpful displaying the information in the User-Agent header to the user in its raw form to help the user identify the associated SIP client. This is firstly because most users are not aware of the software version of the communication clients that they are using. Secondly, the make and/or model information may reflect the original supplier of the communication client and not the “brand” with which the user is familiar. For Plain Old Telephone Service (POTS) services, the end user might not even be aware of the existence (never mind make/model) of a SIP Broadband Loop Carrier (BLC) or Access Gateway Control Function (AGCF) in the service provider's network for their POTS “Main Line”. In some embodiments, the information in the User-Agent header may be suitable for display in its raw form and, as such, may be displayed to the user.

In general, data included in the messaging may be transformed into a more meaningful or informative form for displaying to the user or may be extracted from the messaging for display to the user. Transformation may be implemented using a database of rules maintained by the service provider which match on data included in the messaging, for example in the User-Agent string, to obtain the client-specific identifiers.

For example, a SIP client may send the following in a SIP REGISTER message:

User-Agent: CommPortal Communicator Desktop 1.2.2 stamp 65081.

The service provider might have a rule that matches the existence of “CommPortal Communicator” in the User-Agent header of a SIP REGISTER message, and generates an identifier containing the branded name of the SIP client (for example, “BRAND NAME Communicator”). There may be a further rule which matches “CommPortal Communicator Desktop” to generate an identifier that identifies the underlying platform of the soft client (which, in this case, identifies that the soft user agent is running on a desktop computer rather than on, for example, a mobile phone). In some embodiments, the string “Desktop” may be identified in the User-Agent string and may be used to generate the identifier without initially being mapped using one or more such rules.

However, the contents of the User-Agent string may not be sufficient to uniquely identify each of the user's communication clients. In other words, it may be possible to generate identifiers for the first and second communication clients 130, 140 using a parameter, where the first and second identifiers are not different from each other. This would not facilitate disambiguation by the user between the first and second communication clients 130, 140.

For example, the user may have two identical hard phones or the communication client may not provide the User-Agent strings. In this case, one or more further parameters associated with the messaging may be used to generate the first and second, different, client-specific identifiers. The extent to which any of the following may be done depends upon the circumstances.

The further parameter may identify, or may be used to identify, a geographical location associated with a given communication client.

The geographical location may be identified, for example, using the IP address of the communication client (or a node associated therewith) which is identified in one or more messages transmitted to/and or from the communication client. The geographical location of the communication client is likely to be more informative than its IP address for identifying the particular communication client to the user. Although an IP address may not reliably pinpoint the communication client's exact geographical location, databases exist for providing an approximate geographical location such as a town. This may be sufficient to allow a user to distinguish between a hard phone at home and a hard phone in the office. In such cases, a first client-specific identifier may be “TOWN A phone” and a second, different client-specific identifier may be “TOWN B phone”, where TOWN A is associated with the first communication client, TOWN B is associated with the second communication client and TOWN A is different from TOWN B.

The geographical location associated with the communication client may, alternatively or additionally, be identified, using geo-location information included in one or more messages transmitted to and/or received from the communication client. It is becoming increasingly important to be able to precisely pinpoint the geographical location of a caller (for example to the level of the street address) for emergency call services. In IMS, network-supplied information is signaled using the P-Access-Network header. A database lookup, for example that matches a cell tower ID to an understandable location, may be used to convert the cell tower ID into information that is more informative for an end-user.

Other information may be used to assist the user in distinguishing between the communication clients associated with the common AOR.

A device identifier, for example, a MAC address or equivalent, such as a mobile phone's IMEI, associated with a device on which the communication client runs may also be used to help distinguish between communication clients. Although not particularly user friendly, the device identifier can usually be easily found by the user (for example if it is printed on a label on the underside of the phone). The communication client might signal this information using the sip.instance parameter (RFC 5626), if it is a SIP client, or another proprietary mechanism.

In some embodiments, a parameter that is associated with messaging involving a communication client, but which is not necessarily contained within messages themselves, may be used to generate the client-specific identifiers.

For example, the date/time that a given communication client first registered against the common AOR (or a sequence number derived from the first registration order of all of the communication clients) might be used to allow a user to distinguish a brand new communication client from an earlier communication client.

Recent activity (for example communications activity relating to the last call made or answered by a communication client) might also be used to generate the client-specific identifiers. Recent activity information may be obtained by the identification control system 110 in various different ways. For example, information relating to the last call answered by the communication client (for example the caller ID) is generally present in SIP INVITE messages transmitted to SIP clients.

The first and second, different, client-specific identifiers for the first and second communication clients may be generated in accordance with a client-specific identifier generation algorithm. In its most basic form, an algorithm to generate a client-specific identifier might simply generate a client-specific identifier by concatenating together various information elements that may be used to facilitate identification of and disambiguation between the first and second communication clients 130, 140 by the user. For example, the algorithm may combine a communication client type with its associated location to generate the identifiers.

However, since the purpose of the client-specific identifier is to allow the user to distinguish between their communication clients, as well as to identify which communication client is associated with which client-specific identifier, the algorithm may highlight meaningful differences between the communication clients.

For example, the client-specific identifier may, as a default, identify only the make and/or model of the communication client. If all of the communication clients associated with the common AOR are of the same make and/or model, then another parameter may be used instead or additionally (for example to identify the soft client platform). If some but not all of the communication clients are of the same make and/or model then, for example, both the make and/or model and an additional item may be used to are displayed to generate the first and second client-specific identifiers to facilitate identification of and disambiguation between the first and second communication clients 130, 140 by the user.

Thus, in some embodiments, the identification control system 110 generates first and second initial client-specific identifiers for the first and second communication clients 130, 140 respectively based at least partly on at least one selected parameter. The identification control system 110 determines that the first initial client-specific identifier is the same as the second initial client-specific identifier and selects at least one further parameter associated with messaging involving the first and second communication clients. The identification control system 110 then generates the first and second, different, client-specific identifiers for the first and second communication clients respectively based at least partly on the selected at least one further parameter.

At least the client-specific identifiers are transmitted for output to the user via the user interface 160. This may involve transmitting the client-specific identifiers to the user device 150 itself, or may involve transmitting the client-specific identifiers to an intermediate device that then communicates with the user device 150.

The user may supply a replacement identifier to supplement or replace all or part of the automatically generated client-specific identifiers (for example “home phone” to replace “TOWN A phone”). If supported by the communication client for which the user wishes to supply the replacement identifier, the user may be able to enter the replacement identifier into the communication client itself and the communication client may publish the replacement identifier to the identification control system 110 or to another entity using, for example, SIP or another suitable protocol. The user may also be able to supply the replacement client-specific identifier manually through a web portal using the automatically generated client-specific identifier to identify the relevant communication client.

In the event that a user is still unable to uniquely identify their communication clients, they may follow a process to manually disambiguate the communication clients. For example, the user may visit a web page that lists the communication clients that are currently registered against the AOR and currently assigned client-specific identifiers associated with each of the currently registered communication clients. The user has an option to place a test call to a specific communication client, for example by selecting an “identify” button next to each listed communication client. This causes the identified communication client to ring or generate another form of alert momentarily. Having identified the ringing communication client, the user may enter a replacement client-specific identifier for that communication client. This client-specific identifier is stored persistently to avoid the user having to repeat this process.

In some cases, the user may select or otherwise identify at least one of the communication clients for which the client-specific identifiers have been generated and output to the user via the user interface 160. The identification control system 110 receives the user's selection. In some embodiments, the identification control system 110 or a telephony service control system configures or controls at least one telephony service feature based on the selection. Such features may include, for example a “call manager” service allowing the user to specify rules to control which communication clients are to ring when calls are made to the AOR; when initiating a “click to dial” call, the user wishes to make the call from one of their devices, whereas sometimes there would be an undesirable behavior where all of the registered communication clients would ring; and when using a user interface to transfer calls between a user's communication clients.

There are various techniques whereby identification control system 110 can discover which communication clients are associated with a given address of record, obtain the client-specific identifiers for the communication clients and route messages to a specific communication client. The details depend upon the environment in which the service is being deployed. Embodiments are described below in relation to the IMS architecture, where the service is being provided using an Application Server (AS). Where possible, these embodiments try to leverage existing SIP standards.

In some embodiments, SIP messages are routed to a specific SIP client using the GRUU assigned to that SIP client. This requires that the client-specific identifier be correlated to the GRUU.

In such embodiments, the AS deduces the client-specific identifier associated with a given SIP client from the REGISTER message received from that SIP client at the time of registration and associates the client-specific identifier with the GRUU assigned to the registration.

To do this effectively, the AS accesses various headers in the SIP REGISTER message, such as the User-Agent header. Before 3GPP Release 8, such information was inaccessible to the AS. In Release 8, an “Include Register Request” option was added whereby the S-CSCF includes a complete copy of the received REGISTER message in the third-party registration sent to the AS (see 5.4.1.7A of 3GPP 24.229). The AS can also learn the GRUU that the S-CSCF has assigned to the SIP client using the “Include Register Response” option.

In some embodiments, the AS persistently stores the client-specific identifier in association with the GRUU. Although the AS is able to query on-demand the SIP clients currently registered against a given AOR and their GRUUs (for example by subscribing to the reg event, with the RFC5628 extension), there is no easy way in IMS to query on demand all of the other data provided by the SIP client in the REGISTER message at registration time.

In some embodiments, SIP messages are routed using Caller Preferences.

The primary limitation with the use of Caller Preferences is the general lack of support in SIP clients for explicitly supplying the necessary feature tags in the REGISTER message as outlined in RFC 3840. The SIP Registrar (for example the S-CSCF) may be enhanced to implicitly associate one or more feature tags with the registration of the SIP client, based upon data in or associated with the REGISTER message. The one or more feature tags may include the client-specific identifier, determined in the manner described above, or may include data that the AS may combine as required to generate the client-specific identifier.

With this enhancement to the S-CSCF, the AS may use techniques already defined in the SIP standards as follows. The AS can discover all of the SIP clients (including their associated feature tags which can include the client-specific identifier element(s)) registered against a given AOR using standard IMS-defined techniques, such as subscribing to the reg event package (RFC3680) and looking at the “unknown-param” element in the subsequent notification. To send a SIP message to the SIP client(s) that match the feature tag (i.e. to send a SIP message to a SIP client using the client-specific identifier), the AS includes an Accept-Contact header in the SIP message to the S-CSCF, as described in RFC3841. Alternatively, the AS can also learn the GRUU of one or more of the SIP clients from the reg event (RFC5628 extension), and use the GRUU to send the message to the specific SIP client.

In some embodiments, the Proxy Call Session Control Function (P-CSCF) could be configured to insert the feature tags into the REGISTER message before forwarding the REGISTER message to the S-CSCF, as though the registering SIP client itself supported the feature tags. The P-CSCF does not typically maintain any state about other SIP clients registered against the AOR. Therefore, it is more natural for the P-CSCF to insert a separate features tag for each client-specific identifier element and have the AS or S-CSCF implement the logic to use information received from the P-CSCF to derive or generate the client-specific identifier(s).

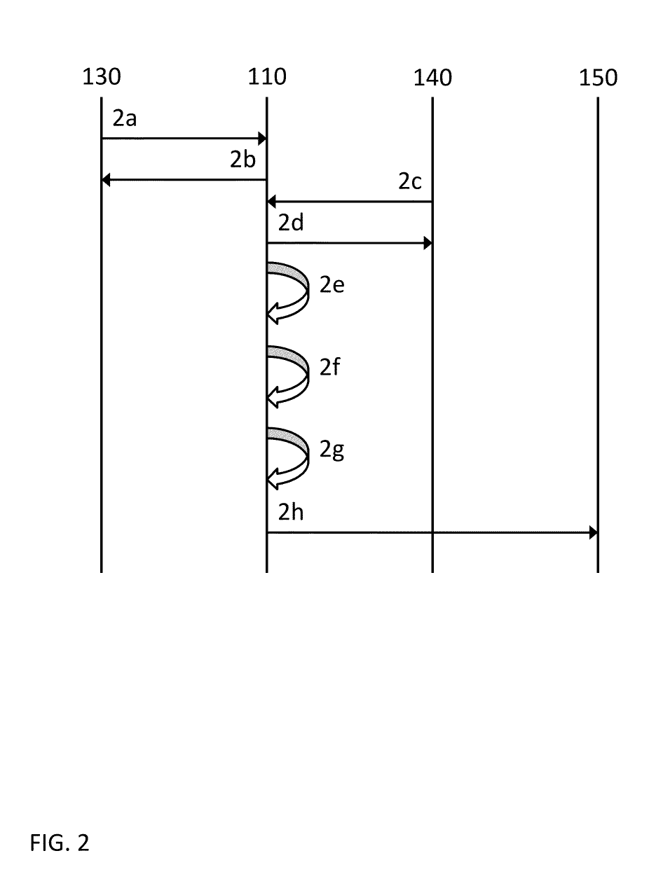

FIG. 2 is a message flow diagram showing a method in accordance with some embodiments.

The method may be implemented in the communications system 100 described above and depicted in FIG. 1 for facilitating the identification of communication clients 130, 140 via a user interface 160. The communication clients use a communication protocol, for example SIP, that is capable of supporting a plurality of communication clients which are addressable using a common address of record.

At steps 2a and 2b, the identification control system 110 receives a SIP message, for example a SIP REGISTER message, from the first SIP client 130 and acknowledges receipt of the same.

Similarly, at steps 2c and 2d, the identification control system 110 receives a SIP message, for example a SIP REGISTER message, from the second SIP client 140 and acknowledges receipt of the same.

At step 2e, the identification control system 110 identifies that at least the first and second communication clients 130, 140 are associated with a common address of record.

At step 2f, the identification control system 110 selects at least one parameter associated with SIP messaging that involves at least the first and second communication clients 130, 140.

At step 2g, the identification control system 110 generates first and second, different, client-specific identifiers for the first and second communication clients 130, 140 respectively based at least partly on the selected at least one parameter. The first and second client-specific identifiers facilitate identification of and disambiguation between the first and second communication clients 130, 140 by the user.

At step 2h, the identification control system 110 transmits at least the first and second client-specific identifiers to the user device 150 for output to the user via the user interface 160.

As such, a human-friendly identifier is assigned for each registered communication client or communication device, such that a service may display this to the end-user though a user interface (e.g. web portal, client application etc.) and route messages to the device in question (either using the human-friendly identifier, or by using another identifier which can be correlated with the human-friendly identifier).

To make this process as user-friendly as possible, the human-friendly identifier is generated automatically, i.e. without the user having to manually enter a suitable identifier for the device. The user may then manually override this according to personal preference, or to handle corner cases where the user cannot disambiguate the devices.

Various measures (for example, a computer-implemented method, apparatus, a system and a computer program product) for facilitating the identification of communication clients via a user interface are provided. The communication clients use a communication protocol capable of supporting a plurality of clients which are addressable using a common address of record. At least a first and a second communication client associated with a common address of record are identified. At least one parameter associated with messaging involving the first and second communication clients are selected. The messaging uses the communication protocol. First and second, different, client-specific identifiers for the first and second communication clients respectively are generated based at least partly on the selected at least one parameter. The first and second client-specific identifiers facilitate identification of and disambiguation between the first and second communication clients by a user. At least the first and second client-specific identifiers are transmitted for output to the user via the user interface.

In some embodiments, more than one parameter associated with the messaging is selected, and the first and second, different, client-specific identifiers are generated based at least partly on the selected more than one parameter.

In some embodiments, the first and second, different, client-specific identifiers for the first and second communication clients respectively are generated based at least partly on data associated with one or more messages communicated to and/or from the first and/or second communication client.

In some embodiments, the first and second, different, client-specific identifiers for the first and second communication clients respectively are generated based at least partly on data included in one or more messages communicated to and/or from the first and/or second communication client.

In some embodiments, at least one of the one or more messages is associated with registering the first and/or second communication client against the common address of record.

In some embodiments, at least one of the first and second, different, client-specific identifiers identifies the type of the first and/or second communication client respectively.

In some embodiments, at least one of the first and second, different, client-specific identifiers identifies a geographic location associated with first and/or second communication client respectively.

In some embodiments, the first and second, different, client-specific identifiers are retrieved from a database.

In some embodiments, first and second initial client-specific identifiers for the first and second communication clients respectively are generated based at least partly on said selected at least one parameter. It is determined that the first initial client-specific identifier is the same as the second initial client-specific identifier. At least one further parameter associated with messaging involving the first and second communication clients is selected. The first and second, different, client-specific identifiers for the first and second communication clients respectively are generated based at least partly on the selected at least one further parameter.

In some embodiments, a telephony service control request identifying the first and/or second communication client is received, and a telephony service involving the first and/or second communication client is controlled based on the received telephony service control request.

The above embodiments are to be understood as illustrative examples of the invention. Further embodiments of the invention are envisaged.

For example, although embodiments have been described in which identification of the communication clients by the user is used to configure or control a telephony service, other embodiments are envisaged. For example, as explained above the communication clients are associated with a common AOR. When a call is received to the AOR, some or all of the registered communication clients ring and the call may be answered on one of those communication clients. In some embodiments, client-specific identifiers for all of the registered communication clients may be transmitted to the user for output via the user interface 160 for information purposes. For example, the particular communication client on which the call has been answered could be emphasized so that the user can determine the device on which the call has been answered. Further embodiments are envisaged in which the user may wish to deregister one or more of the communication clients from the AOR. This is facilitated where the user is able to readily identify the communication clients currently associated with the AOR.

Note, whilst the embodiments described herein involve the Session Initiation Protocol (SIP), it should be understood that the terms Session Initiation Protocol and SIP as used herein are intended to include future protocols which are based at least part on the Session Initiation Protocol and/or which provide similar function to SIP. For example, instead of the AOR being associated with a SIP identifier, the AOR may be associated with an XMPP identifier. In such cases, appropriate telecommunications protocols may be used for communications within the communications system 100.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A computer-implemented method for facilitating the identification of communication clients via a user interface, the communication clients using a communication protocol capable of supporting a plurality of clients which are addressable using a common address of record, the method comprising:
identifying at least a first and a second communication client associated with a common address of record;
selecting at least one parameter associated with messaging involving the first and second communication clients, the messaging using said communication protocol;
generating first and second, different, client-specific identifiers for the first and second communication clients respectively based at least partly on said selected at least one parameter, the first and second client-specific identifiers facilitating identification of and disambiguation between the first and second communication clients by a user; and
transmitting at least the first and second client-specific identifiers for output to the user via the user interface.

2. A method according to claim 1, comprising:
selecting more than one parameter associated with the messaging; and
generating the first and second, different, client-specific identifiers based at least partly on said selected more than one parameter.

3. A method according to claim 1, comprising generating the first and second, different, client-specific identifiers for the first and second communication clients respectively based at least partly on data associated with one or more messages communicated to and/or from the first and/or second communication client.

4. A method according to claim 1, comprising generating the first and second, different, client-specific identifiers for the first and second communication clients respectively based at least partly on data included in one or more messages communicated to and/or from the first and/or second communication client.

5. A method according to claim 3, wherein at least one of the one or more messages is associated with registering the first and/or second communication client against the common address of record.

6. A method according to claim 4, wherein at least one of the one or more messages is associated with registering the first and/or second communication client against the common address of record.

7. A method according to claim 1, wherein at least one of the first and second, different, client-specific identifiers identifies the type of the first and/or second communication client respectively.

8. A method according to claim 1, wherein at least one of the first and second, different, client-specific identifiers identifies a geographic location associated with first and/or second communication client respectively.

9. A method according to claim 1, comprising retrieving the first and second, different, client-specific identifiers from a database.

10. A method according to claim 1, comprising:
generating first and second initial client-specific identifiers for the first and second communication clients respectively based at least partly on said selected at least one parameter;
determining that the first initial client-specific identifier is the same as the second initial client-specific identifier;
selecting at least one further parameter associated with messaging involving the first and second communication clients; and
generating the first and second, different, client-specific identifiers for the first and second communication clients respectively based at least partly on said selected at least one further parameter.

11. A method according to claim 1, comprising:
receiving a telephony service control request identifying the first and/or second communication client; and
controlling a telephony service involving the first and/or second communication client based on the received telephony service control request.

12. Apparatus for facilitating the identification of communication clients via a user interface, the communication clients using a communication protocol capable of supporting a plurality of clients which are addressable using a common address of record, the apparatus comprising:
one or more processors configured to identify at least a first and a second communication client associated with a common address of record;
one or more processors configured to select at least one parameter associated with messaging involving the first and second communication clients, the messaging using said communication protocol;
one or more processors configured to generate first and second, different, client-specific identifiers for the first and second communication clients respectively based at least partly on said selected at least one parameter, the first and second client-specific identifiers facilitating identification of and disambiguation between the first and second communication clients by a user; and
one or more transmitters operable to transmit at least the first and second client-specific identifiers for output to the user via the user interface.

13. A computer program product comprising a non-transitory computer-readable storage medium having computer readable instructions stored thereon, the computer readable instructions being executable by a computerized device to cause the computerized device to perform a method for facilitating the identification of communication clients via a user interface, the communication clients using a communication protocol capable of supporting a plurality of clients which are addressable using a common address of record, the method comprising:
identifying at least a first and a second communication client associated with a common address of record;
selecting at least one parameter associated with messaging involving the first and second communication clients, the messaging using said communication protocol;
generating first and second, different, client-specific identifiers for the first and second communication clients respectively based at least partly on said selected at least one parameter, the first and second client-specific identifiers facilitating identification of and disambiguation between the first and second communication clients by a user; and
transmitting at least the first and second client-specific identifiers for output to the user via the user interface.
